(19) United States
(12) Patent Application Publication
(10) Pub. No.: US 2013/0003867 A1
(43) Pub. Date: Jan. 3, 2013

(54) VIDEO DISPLAY DEVICE

(76) Inventors: Satoko Miki, Tokyo (JP); Satoru Tokuyama, Tokyo (JP)

(21) Appl. No.: 13/634,492

(22) PCT Filed: Jun. 6, 2011
(86) PCT No.: PCT/JP2011/003178

§ 371 Date: Sep. 12, 2012

(30) Foreign Application Priority Data
Jun. 11, 2010 (JP) 2010-134087
Feb. 3, 2011 (JP) PCT/JP2011/000599

(51) Int. Cl. H04N 7/26

(52) U.S. Cl. 375/240.25; 375/E07.027

(57) ABSTRACT

A decode timing generation unit is configured so that when there is a change in the video data input at the input terminal, by moving the reference time into the future, it generates a decode timing signal immediately after the first acquisition of the DTS of a decodable frame following the change. The decode timing generation unit is configured so that the decode timing signal is generated when only a portion of the decodable frame is acquired, before the entirety of the decodable frame is acquired. In addition, the display timing generation unit is configured so that when there is a change in the video data input at the input terminal, by moving the reference time into the future, it generates a display timing immediately after the first acquisition of the PTS of a decodable frame after the change.

### TECHNICAL FIELD

The present invention relates to a video display device, more particularly to a video display device that displays video pictures of digitally broadcast programs.

### BACKGROUND ART

Digital compression technology such as MPEG (Moving Picture Experts Group)-2 and MPEG-4 is used in the digital broadcasting of programs. Television receivers (also referred to below as television sets) that receive digital broadcasts receive transmitted data and broadcast signals defined in broadcast standards and operational guidelines, decode the received transmitted data and broadcast signals under defined conditions, and display video programs. When a television viewer selects a channel, accordingly, there is a longer delay than with analog broadcasting before the program picture of the selected channel appears on the display screen of the television set; it is a problem to require the long time before a picture is output after channel selection.

As a way of mitigating this problem, a digital broadcast receiver that reduces the psychological stress on the viewer by outputting another picture during the time until the program picture of the selected channel is output has been proposed (see, for example, Patent Reference 1). A device for separating multiplexed data that is configured to improve the reproduction starting time response by comparing data indicating the decode starting time in a video decoder with data indicating the time and, according to the result of the comparison, writing video data in a video code buffer at a higher transfer rate than specified in the bit stream has also been proposed (see, for example, Patent Reference 2). A data processing apparatus that decodes earlier, by a fixed length of time, from the difference between the data arrival time and the decoding time has furthermore been proposed (see, for example, Patent Reference 3).

### PRIOR ART REFERENCES

### Patent References

Patent Reference 1: Japanese Patent Application Publication No. 2005-295028
Patent Reference 2: Japanese Patent Application Publication No. H06-333341
Patent Reference 3: Japanese Patent Application Publication No. 2009-212696

### SUMMARY OF THE INVENTION

### Problems to be Solved by the Invention

The time until the desired program is seen cannot be shortened by inserting another picture during the time until the program picture of the selected channel is output as in the art disclosed in Patent Reference 1. The art disclosed in Patent Reference 2 is art for advancing the picture output timing of an already recorded program; when the channel of a broadcast program is selected, it cannot advance the picture output of the program on the selected channel, and cannot shorten the time that elapses until picture output. The art disclosed in Patent Reference 3 requires a large additional module and cannot shorten the time by more than a certain amount.

Since the time until picture output of the program on the selected channel cannot be shortened by the art disclosed in Patent References 1 and 2, and the time until picture output of the program on the selected channel cannot be adequately shortened by the art disclosed in Patent Reference 3, inconvenience for the user is a problem.

An object of the present invention is to provide a video display device that can shorten the time from a change in input video data to initial display of the video picture, for example, the time from selection of a channel to output of a program picture on the selected channel, as much as possible by a method with a small additional module.

### Means for Solving the Problem

A video display device according to the present invention is a video display device for decoding and displaying coded video data including a plurality of frames, comprising input means for input of the video data, decode timing generation means for generating decode timing signals indicating decode timings of the frames of the video data input to the input means, decoding means for decoding the frames of video data input to the input means in accordance with the decode timing signals, display timing generation means for generating display timing signals indicating display timings at which to output the frames decoded by the decoding means, and output means for output of the decoded frames in accordance with the display timing signals. When there is a change in the video data input to the input means, by setting a reference time in the future, the decode timing generation means generates a decode timing signal at a time immediately following acquisition of the DTS of the first decodable frame following the change. When there is a change in video data input to the input means, by setting a reference time in the future in the display timing generation process, the display timing generation means generates a display timing at a time immediately following acquisition of the PTS of the first decodable frame following the change.

### Effects of the Invention

With the video display device of the present invention, when the video data input to the input means change, at the time when the first decodable frame is acquired after the change, a decode timing signal is generated by the decode timing generation means and the first decodable frame is decoded by the decoding means. Furthermore, when it is decided that a decodable frame is present, a decode timing signal is generated immediately, regardless of the DTS, and the decodable frame is decoded. Also, at the time when the first displayable frame after the change in the video data input to the input means is acquired, a display timing signal is generated by the display timing generation means and the first displayable frame is output by the output means. Furthermore, when it is decided that a displayable frame is present, a display timing signal is generated immediately, regardless of the PTS, and the displayable frame is displayed.

The time from a change in the video data input to the input means to display of the first video picture can thereby be shortened. The time from selection of a channel to output of a program picture on the selected channel can accordingly be shortened as much as possible.

### BRIEF DESCRIPTION OF THE DRAWINGS

FIG. 1 is a block diagram showing the structure of a video display device 1 in a first embodiment of the invention.

FIG. 2 is a flowchart illustrating a processing procedure in the decode timing generation unit 14 pertaining to the decode timing generation process.

FIG. 3 is a flowchart illustrating a processing procedure in the display timing generation unit 17 pertaining to the display timing generation process.

FIG. 4 schematically illustrates the frame display timing based on the operation of the display timing generation unit 17.

FIG. 5 is a flowchart illustrating a processing procedure in the decode timing generation unit pertaining to the decode timing generation process in the conventional art.

FIG. 6 is a flowchart illustrating a processing procedure in the display timing generation unit pertaining to the display timing generation process in the conventional art.

FIG. 7 is a flowchart illustrating a processing procedure in the decode timing generation unit 14 pertaining to the decode timing generation process in a second embodiment of the invention.

FIG. 8 is a flowchart illustrating a processing procedure in the display timing generation unit 17 pertaining to the display timing generation process in the second embodiment of the invention.

FIG. 9 schematically illustrates the frame display timing based on the operation of the display timing generation unit 17 in a third embodiment of the invention.

FIG. 10 schematically illustrates the frame display timing based on the operation of the display timing generation unit 17 in a fourth embodiment of the invention.

FIG. 11 is a flowchart illustrating a processing procedure in the decode timing generation unit 14 pertaining to the decode timing generation process in a fifth embodiment of the invention.

FIGS. 12(a) and 12(b) schematically illustrate the relation between accumulation in the decode buffer 13 and the decode timing and display timing.

FIG. 13 is a flowchart illustrating a processing procedure in the decode timing generation unit 14 pertaining to the decode timing generation process in a sixth embodiment of the invention.

FIG. 14 is a block diagram illustrating the structure of the decode timing generation unit pertaining to the decode timing generation process in the sixth embodiment of the invention.

FIG. 15 is a flowchart illustrating a processing procedure in the display timing generation unit 17 pertaining to the display timing generation process in the sixth embodiment of the invention.

FIG. 16 is a block diagram illustrating the structure of the display timing generation unit pertaining to the display timing generation process in the sixth embodiment of the invention.

FIG. 17 is a flowchart illustrating a processing procedure in the decode timing generation unit 14 pertaining to the decode timing generation process in a seventh embodiment of the invention.

FIG. 18 is a block diagram illustrating the structure of the decode timing generation unit pertaining to the decode timing generation process in the seventh embodiment of the invention.

FIG. 19 is a flowchart illustrating a processing procedure in the display timing generation unit 17 pertaining to the display timing generation process in the seventh embodiment of the invention.

FIG. 20 is a block diagram illustrating the structure of the display timing generation unit pertaining to the display timing generation process in the seventh embodiment of the invention.

### MODE FOR CARRYING OUT THE INVENTION

### First Embodiment

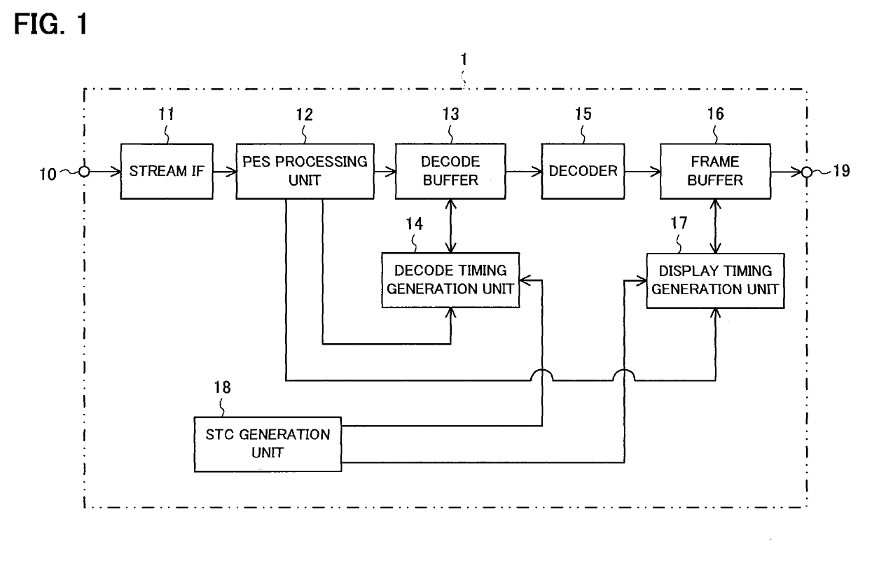

FIG. 1 is a block diagram showing the structure of a video display device 1 in a first embodiment of the invention. The video display device 1 comprises an input terminal 10, a stream IF (interface) 11, a PES (Packetized Elementary Stream) processing unit 12, a decode buffer 13, a decode timing generation unit 14, a decoder 15, a frame buffer 16, a display timing generation unit 17, a system time clock (STC) generation unit 18, and an output terminal 19. The input terminal 10 is equivalent to the input means, the decode timing generation unit 14 is equivalent to the decode timing generation means, the decoder 15 is equivalent to the decoding means, the display timing generation unit 17 is equivalent to the display timing generation means, and the output terminal 19 is equivalent to the output means.

Video data included in a digital broadcast signal broadcast from a broadcasting station, for example, and received by a receiving antenna (not shown) are input to the input terminal 10. The video data input to the input terminal 10 include a plurality of frames, which are input to the stream interface 11 one frame at a time.

The stream interface 11 takes PES packets from the input video data and passes them to the PES processing unit 12. PES packets are packetized data of compressively coded video. Video is stored in PES packets in the units used for decoding and reproduction. PES packets are also the units used for media reproduction time control.

A PES packet is divided up and transmitted in the payloads of a plurality of transport stream (TS) packets having the same PID (Packet Identification) number. A TS comprises TS packets having a fixed length of 188 bytes; TS's are used in real-time transmission and communication systems, including digital broadcasting. Each TS packet has a 4-byte header; the remaining 184 bytes constitute the payload. The PID is included in the header to enable the packet to be identified.

The PES processing unit 12 analyzes information included in the PES headers furnished from the stream interface 11, furnishes the information to the decode timing generation unit 14 and display timing generation unit 17, and furnishes the payload data to the decode buffer 13.

The STC generation unit 18 furnishes a system time clock (STC) generated by using the program clock references (PCR's) included in the TS or the system clock references (SCR's) included in the PES to the decode timing generation unit 14 and display timing generation unit 17. The STC is a time reference value for picture or sound synchronization, a PCR is data indicating time at the program level, and an SCR is data indicating time at the stream level.

The decode timing generation unit 14 generates decode timing signals representing the timing of decoding by the decoder 15 on the basis of information included in the PES packets furnished from the PES processing unit 12 and passes the generated decode timing signal to the decode buffer 13. More specifically, when a change in the video data input to the input terminal 10 occurs, the decode timing generation unit 14 generates a decode timing signal at the time when the first decodable frame is acquired after the change: in this embodiment, at the time when the entire decodable frame is acquired. The start of video stream input to the input terminal 10 is also a change in video data input to the input terminal 10.

The decode buffer 13 temporarily stores the payload data furnished from the PES processing unit 12 and analyzes data on and below the PES layer. The decode buffer 13 passes the video data to the decoder 15 in accordance with decoding timings indicated by the decode timing signals furnished from the decode timing generation unit 14. When furnished with video data from the decode buffer 13, the decoder 15 decodes the video data and passes the decoded data to the frame buffer 16.

On the basis of information included in the PES packets furnished from the PES processing unit 12, the display timing generation unit 17 generates display timing signals indicating timings for output of the video data from the frame buffer 16 and display of the video data on a display unit (not shown), and passes the generated display timing signals to the frame buffer 16.

The frame buffer 16 temporarily stores the decoded data passed from the decoder 15 and outputs the decoded data through the output terminal 19 to the display unit (not shown) in accordance with the display timings indicated by the display timing signals passed from the display timing generation unit 17. A video picture is thereby displayed on the display unit.

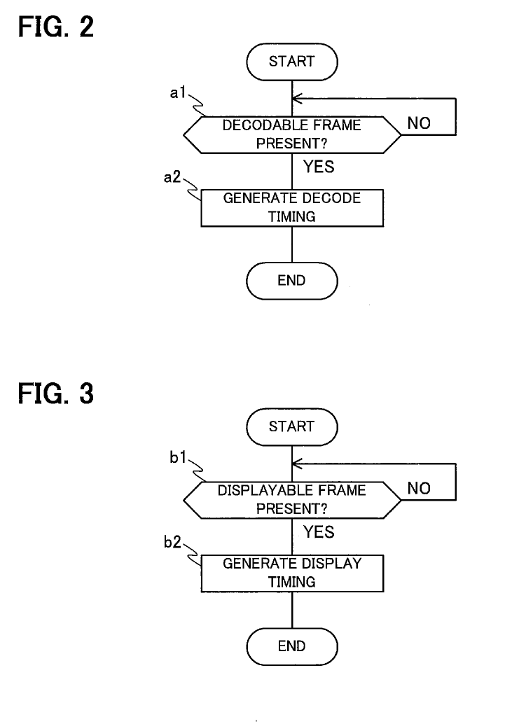

FIG. 2 is a flowchart illustrating a processing procedure in the decode timing generation unit 14 pertaining to the decode timing generation process in this embodiment. The flowchart shown in FIG. 2 contemplates application of the video display device 1 in this embodiment to a television receiver; when input of a video data stream to the stream interface 11 starts immediately after the television receiver is turned on, or when the type, status, etc. of the input stream to the stream interface 11 changes owing to a broadcast channel selection operation by the user etc., this process starts with a transition to step a1.

In step a1, the decode timing generation unit 14 decides whether a decodable frame, the whole of which can be decoded, is present, that is, whether a decodable frame has been acquired through the stream interface 11. The decode timing generation unit 14 decides whether a decodable frame is present on the basis of the information included in the PES packets furnished from the PES processing unit 12.

More specifically, when a frame coded without use of inter-frame prediction, such as a frame that becomes an I (intra-coded) frame, described later, is input to the stream interface 11, the whole frame being able to be decoded with just the video data pertaining to the frame, the decode timing generation unit 14 decides that a decodable frame is present.

When a frame coded by use of intra-frame prediction is input to the stream interface 11, the entire frame being unable to be decoded with just the video data pertaining to the frame, the decode timing generation unit 14 decides whether a decodable frame is present by checking whether the other frame(s) that were used in coding the frame of interest have been input. If the other frame(s) used to code a frame coded by use of intra-frame prediction are input before that frame is input, the whole frame can be decoded, so the decode timing generation unit 14 decides that a decodable frame is present. If another frame used to code the frame has not been input, the whole frame of interest cannot be decoded, so the decode timing generation unit 14 decides that the frame is not a decodable frame and that no decodable frame is present.

More specifically, in this embodiment, the decode timing generation unit 14 decides in step a1 whether a decodable frame is present by checking whether the entire decodable frame has been acquired, or more precisely, whether all of the video data pertaining to the decodable frame have been acquired. The decode timing generation unit 14 decides that a decodable frame is present when it decides that the entire decodable frame has been acquired, and decides that no decodable frame is present when it decides that the entire decodable frame has not been acquired. If it is decided in step a1 that a decodable frame is present, the process proceeds to step a2; if it is decided that a decodable frame is not present, the process waits until it is decided that a decodable frame is present.

In step a2, the decode timing generation unit 14 generates a decode timing signal that indicates the timing of decoding by the decoder 15 and passes the decode timing signal to the decode buffer 13. After the processing in step a2 ends, the entire processing procedure ends.

As described above, by following the flowchart shown in FIG. 2, the decode timing generation unit 14 in this embodiment generates a decode timing signal when it decides that a decodable frame is present. The process illustrated by the flowchart shown in FIG. 2 starts with a change in the video data input to the input terminal 10. When it is decided in step a1 that a decodable frame has been acquired, the process proceeds to step a2. More specifically, the process proceeds to step a2 when it is decided in step a1 that the whole of a decodable frame has been acquired. That is, when a change in the video data input to the input terminal 10 occurs, a decode timing signal is generated at the time when the first decodable frame is acquired after the change: in this embodiment, at the time when the entire decodable frame is acquired. So, immediately after the input stream to the stream interface 11 changes, the decode timing generation unit 14 generates a decode timing signal at the timing when it detects the first frame, the whole of which can be decoded: at the timing when it detects the first I frame following the sequence header, if a sequence header is inserted in each GOP (Group of Pictures).

FIG. 3 is a flowchart illustrating a processing procedure in the display timing generation unit 17 pertaining to the display timing generation process in this embodiment. The flowchart shown in FIG. 3, like the flowchart shown in FIG. 2, contemplates application of the video display device 1 in this embodiment to a television receiver: when input of video data to the stream interface 11 starts immediately after the television receiver is turned on, or when the type, status, etc. of the input stream to the stream interface 11 changes owing to a broadcast channel selection operation by the user etc., this process starts with a transition to step b1.

In step b1, the display timing generation unit 17 decides whether a displayable frame is present. The display timing generation unit 17 checks information included in the PES packets furnished from the PES processing unit 12 to see whether a displayable frame is present. More specifically, when it is detected that the data output from the decoder 15 and stored in the frame buffer 16 have become displayable, i.e., when it is detected that decoding is completed and the display order agrees with the original picture order, the display timing generation unit 17 decides that a displayable frame is present. When it is decided in step b1 that a displayable frame is present, the process proceeds to step b2; when it is decided that a displayable frame is not present, the process waits until a displayable frame is decided to be present.

In step b2, the display timing generation unit 17 generates a display timing signal indicating a display timing and furnishes it to the frame buffer 16. After the processing in step b2 ends, the entire processing procedure ends.

In this embodiment, the display timing generation unit 17 generates a display timing signal when it detects that the data output from the decoder 15 and stored in the frame buffer 16 have become displayable, i.e., that decoding is completed and the display order agrees with the original picture order, as illustrated in the flowchart shown in FIG. 3. A display timing signal is thereby generated at a timing when decoding is completed and the display order agrees with the original picture order. For example, the first displayable timing following a stream change is the timing when decoding of the first I frame following the stream change is completed, or the timing when all data pertaining to the first I frame following the stream change have been decoded, and a display timing signal is generated at that timing.

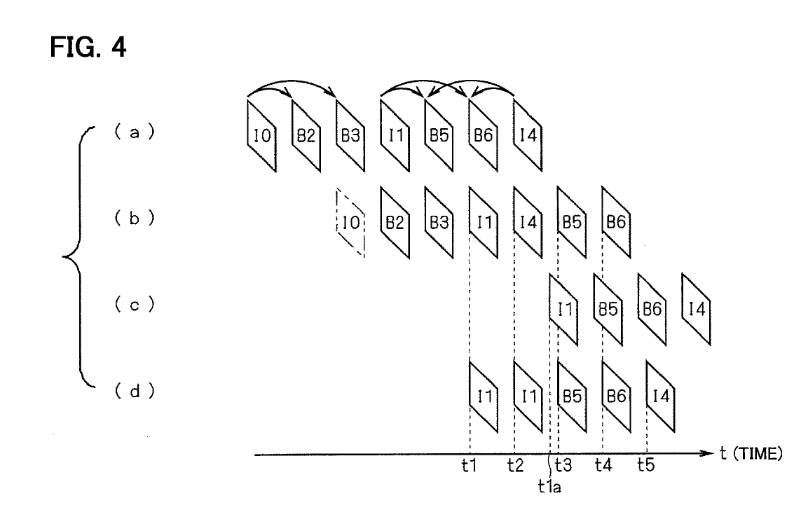

FIG. 4 schematically illustrates the frame display timing based on the operation of the display timing generation unit 17 in this embodiment. FIG. 4 also shows the order of frames in the original picture and the order of frames in the transmitted and received stream. FIG. 4 shows the frame display timing in the conventional art as a ‘normal display’ and the frame display timing in this embodiment as a ‘high-speed channel selection display’. In FIG. 4, the frames of the original picture are shown at (a), the frames in the transmitted and received stream are shown at (b), the frames of the normal display are shown at (c), and the frames of the high-speed channel selection display are shown at (d). For ease of understanding, delays such as encoding delays, transmission delays, and decoding delays are expressed as zero in FIG. 4. It is also assumed that the delays and processing times do not fluctuate.

In FIG. 4, Ix (x is a positive integer) represents an I frame, and Bx (x is a positive integer) represents a B frame (Bi-directional Predicted Frame). An I frame is encoded without use of inter-frame prediction; a B frame is encoded by use of inter-frame prediction, selected from among forward prediction, backward prediction, and bi-directional prediction.

In this embodiment, frames B2 and B3 have been generated by predictive conversion using frame T0, and frames B5 and B6 have been generated by predictive conversion using frames I1 and I4. If the original picture included frames I0, B2, B3, I1, B5, B6, I4 in that order as shown at (a) in FIG. 4, the transmitted stream includes frames I0, B2, B3, I1, I4, B5, B6 in that order. If frame I0 is missing from the received stream, as indicated by phantom lines in FIG. 4, and the transmitted stream was received starting from B2, then frames B2 and B3 cannot be decoded, so the decodable and displayable frames are frames I1, B5, B6, and I4. Accordingly, the first decodable frame following the start of stream reception is I1.

In the above-described step a1 in FIG. 2, the decode timing generation unit 14 consequently decides at time t1 that a decodable frame is present. Since the subsequent decoding delay in the decoder 15 is zero, in the above-described step b1 in FIG. 3, the display timing generation unit 17 also decides at time t1 that a displayable frame is present.

The next frame that becomes decodable is I4, which becomes decodable at time t2 and becomes displayable, in keeping with the original picture order, at time t5. The frame to be displayed following frame I1 becomes decodable, and becomes displayable after decoding, at time t3, and the frame to be displayed third, counting from frame I1, becomes decodable and then displayable after decoding at time t4.

When decoding and display are carried out by the conventional art, without applying this embodiment, frame decode timings are indicated by decoding time stamps (DTS's) included in the PES headers, and display timings are indicated by presentation time stamps (PTS's) included in the PES headers. Therefore, the timing at which frame I1 is ultimately displayed is the time t1a indicated by the PTS, as shown at (c) in FIG. 4.

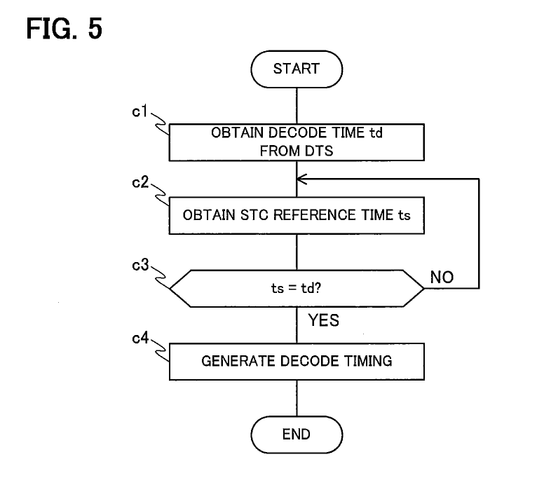

FIG. 5 is a flowchart illustrating a processing procedure in the decode timing generation unit pertaining to the decode timing generation process in the conventional art. FIG. 5 is equivalent to a flowchart illustrating the processing procedure in the decode timing generation process for the normal display shown at (c) in FIG. 4.

In step c1, the decode timing generation unit obtains a decode time td from the DTS. When the decode time td has been obtained by the decode timing generation unit in step c1, the process proceeds to step c2.

In step c2, the decode timing generation unit obtains an STC reference time ts. When an STC reference time ts has been obtained by the decode timing generation unit in step c2, the process proceeds to step c3.

In step c3, the decode timing generation unit decides whether the reference time ts agrees with the decode time td. If it is decided in step c3 that the reference time ts agrees with the decode time td (ts=td), the process proceeds to step c4; if it is decided that the reference time ts does not agree with the decode time td, the process returns to c2, and the processing described above is performed. That is, the decode timing generation unit waits until the reference time ts reaches the decode time td.

In step c4, the decode timing generation unit generates a decode timing signal and passes it to the decode buffer. After the processing in step c4 ends, the entire processing procedure ends. In the conventional art, the decode timing signal is generated at the decode time td indicated by the DTS included in the PES header.

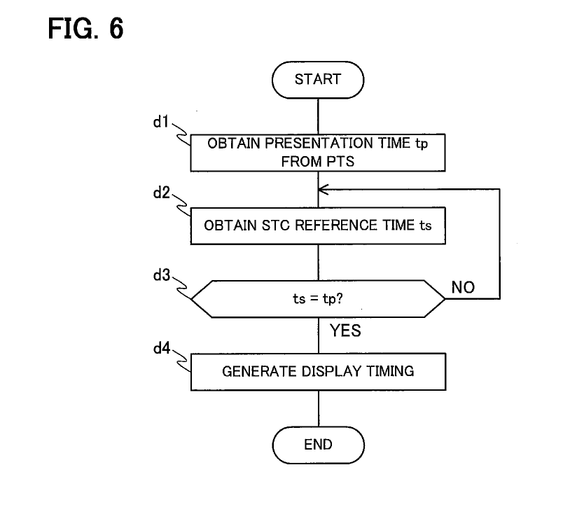

FIG. 6 is a flowchart illustrating a processing procedure in the display timing generation unit pertaining to the display timing generation process in the conventional art. FIG. 6 is equivalent to a flowchart illustrating the processing procedure in the display timing generation process for the normal display shown at (c) in FIG. 4.

In step d1, the display timing generation unit obtains a presentation time tp from the PTS. When the presentation time tp has been obtained by the display timing generation unit in step d1, the process proceeds to step d2.

In step d2, the display timing generation unit obtains an STC reference time ts. When the STC reference time ts has been obtained by the display timing generation unit in step d2, the process proceeds to step d3.

In step d3, whether the reference time ts agrees with the presentation time tp is decided. If it is decided in step d3 that the reference time ts agrees with the presentation time tp (ts=tp), the process proceeds to step d4; if it is decided that the reference time ts does not agree with the presentation time tp, the process returns to step d2 and the processing described above is performed. The display timing generation unit thus waits until the reference time ts reaches the presentation time tp.

In step d4, the display timing generation unit generates a display timing occurrence signal and furnishes it to the frame buffer. After the processing in step d4 ends, the entire processing procedure ends. With the conventional art, the display timing signal is generated at the presentation time tp indicated by the PTS included in the PES header. As shown at (c) in FIG. 4, the timing at which frame I1 is displayed becomes the presentation time t1a indicated by the PTS. In the conventional art, even if the first frame following the stream change becomes displayable before the presentation time t1a indicated by the PTS, the frame is not displayed until the presentation time t1a indicated by the PTS. Therefore, the time from when the video stream starts or is changed until the video picture is displayed is longer in comparison with the high-speed channel selection display illustrated at (d) in FIG. 4 in this embodiment.

In this embodiment, when there is a change in the video data input to the input terminal 10, a decode timing signal is generated at the time when the first decodable frame is obtained after the change, or more specifically, at the time when the entire decodable frame is obtained, and a display timing is generated at the time when a displayable frame is obtained. That is, when it is decided in this embodiment that the received stream includes a decodable frame, a decode timing signal is generated immediately, regardless of the DTS, and the decodable frame is decoded. This timing signal indicates the earliest timing for the decoding of the data of a frame, the whole of which can be decoded, after power-up or channel selection. When it is decided that a displayable frame is present, a display timing signal is generated immediately, regardless of the PTS, and the displayable frame is displayed. This timing signal indicates the earliest timing for the display of the data of a frame, the whole of which can be displayed, after power-up or channel selection. In this embodiment, the first decodable frame to arrive in the received stream is immediately decoded, and the decoded data are immediately displayed.

Accordingly, the time from when the video stream comprising video data input to the input terminal 10 changes until the video picture is displayed can be reduced. The time from when a digital broadcast channel is selected until the picture of a program on the selected channel is displayed can accordingly be reduced as much as possible. When a channel is selected, the time until a picture is displayed following the channel selection can be reduced.

In this embodiment, frames are not displayed in the order in which they were decoded but in the original picture, so an orderly picture can be displayed.

Although methods of generating decode and display timings have been described on a per-frame basis in this embodiment, these methods can be practiced to advantage not only on a per-frame basis but also on a per-field or per-picture basis.

### Second Embodiment

A video display device in a second embodiment of the invention will now be described. The first embodiment was described on the assumption that the video stream data do not fluctuate and that the time needed for processing in the video display device 1 is zero, but in the description of the video display device in the second embodiment, consideration is given to fluctuations and processing delays. Except for the decode timing generation process and display timing generation process, the video display device in this embodiment is identical to the video display device 1 described above in the first embodiment, so the differing parts will be described and descriptions of the common parts will be omitted.

In this embodiment, the decode timing generation unit 14 generates decode timing signals indicating the timing of decoding by the decoder 15 based on information included in the headers of the PES packets furnished from the PES processing unit 12 and the STC furnished from the STC generation unit 18, and passes the generated decode timing signals to the decode buffer 13.

The display timing generation unit 17 generates display timing signals indicating the timing of output of video data from the frame buffer 16 and display of the data on the display unit (not shown) based on information included in the headers of the PES packets furnished from the PES processing unit 12 and the STC furnished from the STC generation unit 18, and passes the generated display timing signals to the frame buffer 16.

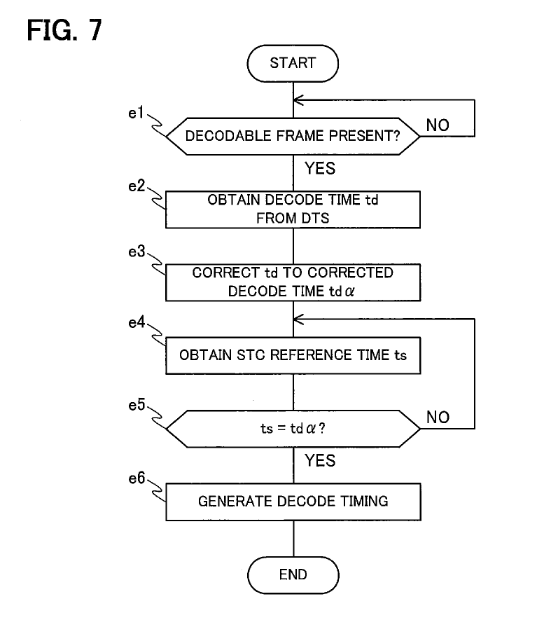

FIG. 7 is a flowchart illustrating a processing procedure in the decode timing generation unit 14 pertaining to the decode timing generation process in this embodiment. Immediately after the decode timing generation process starts, the process illustrated by the flowchart shown in FIG. 2 is performed, as in the first embodiment. In step a2 in FIG. 2, however, besides generating a decode timing signal, the decode timing generation unit 14 obtains the decode time td0 indicated by the DTS of the first decodable frame and the actual decode timing time tc0. The decode timing generation process for the second and subsequent frames is then performed in accordance with the processing procedure illustrated by the flowchart shown in FIG. 7, as described below. When the entire processing procedure in the flowchart shown in FIG. 2 ends, that is, the processing in the flowchart shown in FIG. 7 starts with a transition to step a1.

In step e1, the decode timing generation unit 14 decides whether a decodable frame is present. If it is decided in step e1 that at least part of a decodable frame has been obtained, the decode timing generation unit 14 decides that a decodable frame is present. If it is decided in step e1 that a decodable frame is present, the process proceeds to step e2; if it is decided that a decodable frame is not present, the process waits until a decodable frame is decided to be present.

In step e2, the decode timing generation unit 14 obtains a decode time td from the DTS. When a decode time td has been obtained by the decode timing generation unit 14 in step e2, the process proceeds to step e3.

In step e3, the decode timing generation unit 14 corrects the decode time td obtained in step e2 to a corrected decode time tdα obtained on the basis of the decode time td0 indicated by the DTS of the first decodable frame obtained beforehand and the actual decode timing time tc0. The correction process will be described later. When the decode time td has been corrected to the corrected decode time tdα by the decode timing generation unit 14 in step e3, the process proceeds to step e4.

In step e4, the decode timing generation unit 14 obtains an STC reference time ts. When an STC reference time ts has been obtained by the decode timing generation unit 14 in step e4, the process proceeds to step e5.

In step e5, the decode timing generation unit 14 decides whether the reference time ts agrees with the corrected decode time tdα. If it is decided in step e5 that the reference time ts agrees with the corrected decode time tdα (ts=tdα), the process proceeds to step e6; if it is decided that the reference time ts does not agree with the corrected decode time tdα, the process returns to step e4, and the processing described above is performed. The decode timing generation unit 14 thus waits until the reference time ts agrees with the corrected decode time td.

In step e6, the decode timing generation unit 14 generates a decode timing signal and furnishes it to the decode buffer 13. After the processing in step e6 ends, the entire processing procedure ends.

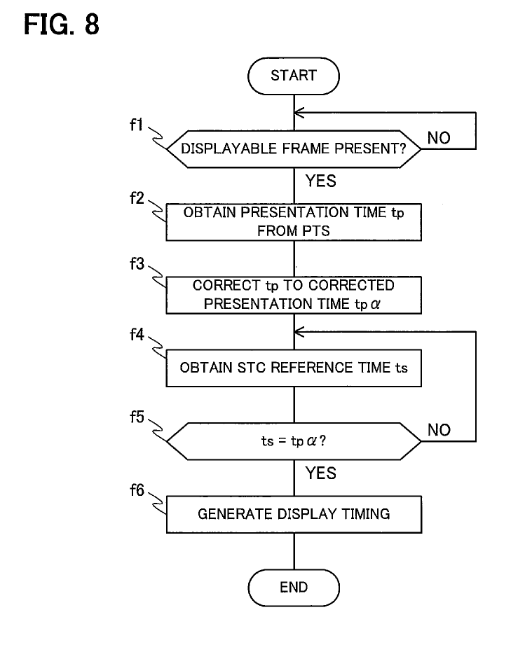

FIG. 8 is a flowchart illustrating a processing procedure in the display timing generation unit 17 pertaining to the display timing generation process in this embodiment. Immediately after the display timing generation process starts, the processing illustrated by the flowchart shown in FIG. 3 is performed, as in the first embodiment. In step b2 shown in FIG. 3, however, besides generating a display timing signal, the display timing generation unit 17 obtains the presentation time tp0 indicated by the PTS of the first displayable frame and the generated display timing tq0. The display timing generation process for the second and subsequent frames is then performed in accordance with the processing procedure illustrated by the flowchart shown in FIG. 8, which will be described below. When the entire processing procedure in the flowchart shown in FIG. 3 ends, that is, the processing illustrated by the flowchart shown in FIG. 8 starts with a transition to step f1.

In step f1, the display timing generation unit 17 decides whether a displayable frame is present. If it is decided in step f1 that a displayable frame is present, the process proceeds to step f2; if it is decided that a displayable frame is not present, the process waits until a displayable frame is decided to be present.

In step f2, the display timing generation unit 17 obtains a presentation time tp from the PTS. When a presentation time tp has been obtained by the display timing generation unit 17 in FIG. 2, the process proceeds to step f3.

In step f3, the display timing generation unit 17 corrects the presentation time tp obtained in FIG. 2 to a corrected presentation time tpα determined on the basis of the presentation time tp0 indicated by the PTS of the first displayable frame, which has already been obtained, and the generated display time tq0. The correction process will be described later. When the presentation time tp has been corrected to the corrected presentation time tpα by the display timing generation unit 17 in step f3, the process proceeds to step f4.

In step f4, the display timing generation unit 17 obtains an STC reference time ts. When the STC reference time ts has been obtained by the display timing generation unit 17 in step f4, the process proceeds to step f5.

In step f5, the display timing generation unit 17 decides whether the reference time ts agrees with the corrected presentation time tpα. If it is decided in step f5 that the reference time ts agrees with the corrected presentation time tpα (ts=tpα), the process proceeds to step f6; if it is decided that the reference time ts does not agree with the corrected presentation time tpα, the process returns to step f4 and the processing described above is performed. The display timing generation unit 17 thus waits until the reference time ts agrees with the corrected presentation time tp.

In step f6, the display timing generation unit 17 generates a display timing occurrence signal and passes it to the frame buffer 16. After the processing in step f6 ends, the entire processing procedure ends.

The decode timing generation unit 14 in this embodiment generates decode timing signals for the second and subsequent frames when the reference time is indicated by the STC agrees with the corrected decode time tdα obtained by correcting the decode time td indicated by the DTS on the basis of the information included in the headers of the PES packets furnished from the PES processing unit 12 and the STC furnished from the STC generation unit 18. The display timing generation unit 17 generates display timing signals when the reference time is indicated by the STC agrees with the corrected presentation time tpa obtained by correcting the presentation time tp indicated by the PTS on the basis of the information included in the headers of the PES packets furnished from the PES processing unit 12 and the STC furnished from the STC generation unit 18.

Even if the input of video stream data to the video display device fluctuates or if the processing from video input to display does not have a fixed delay, an orderly picture can be displayed.

Since timing corrections are made for both the decode timing and the display timing in this embodiment, even if there is a wait before decoded data are displayed, the waiting time is short, and the amount of buffer space used for display can be reduced.

The timing generation correction process will now be described. In this embodiment, the corrected decode time tdα obtained by correcting the DTS for decode timing is calculated by using the decode time td0 indicated by the DTS of the first decodable frame and the actual decode timing time tc0, as given by the equation (1) below.

tdα=td−(td0−tc0) (1)

Here, (td0−tc0) expresses the difference between the decode time td0 indicated by the DTS in the first decodable frame and the actual decode timing time tc0.

The corrected presentation time tpα obtained by correcting the PTS for display timing is calculated by using the presentation time tp0 indicated by the PTS of the first displayable frame and the generated display timing time tq0, as given by the equation (2) below.

tpα=tp−(tp0−tq0) (2)

Here, (tp0−tq0) expresses the difference between the presentation time tp0 indicated by the PTS in the first decodable frame and the actually generated display timing time tq0.

The corrections based on the above equations (1) and (2) will be referred to as ‘linear corrections’ below.

In this embodiment, the decode and display timings of the second and subsequent frames are corrected linearly on the basis of the first decode and display timings. That is, decode timing signals and display timing signals are generated to shift the decode and display timings of the second and subsequent frames by the same amount as the difference between the first decode and display timings.

The frames can therefore be displayed at the same frame intervals as in the original picture. The time from when the input video stream starts or changes until the first video picture is displayed can be reduced as in the first embodiment and, just by making linear corrections, the frames can be displayed at the same frame intervals as in the original picture.

Although methods of correcting both the decode timing and display timing have been described in the first and second embodiments, if the buffer space involved in decoding and display is sufficient, the method of correcting just one of the two can be used.

### Third Embodiment

Whereas the correction method used in timing generation is a linear correction method in the second embodiment, another correction method is used in the third embodiment. Except for the timing generation correction method, the video display device in this embodiment is identical to the video display device in the second embodiment.

The correction process in timing generation in this embodiment will be described. The process up to the generation of the first decode timing and display timing is the same as in the second embodiment. Then, the process waits until the time indicated by the input video data, namely the decode time td indicated by the DTS, and makes that time the second decode timing. This correction is given by the equation (3) below.

tdα=td (3)

The second display timing is made to wait until the time becomes equal to the time indicated by the input video data, namely the presentation time tp indicated by the PTS. This correction is given by the equation (4) below.

tpα=tp (4)

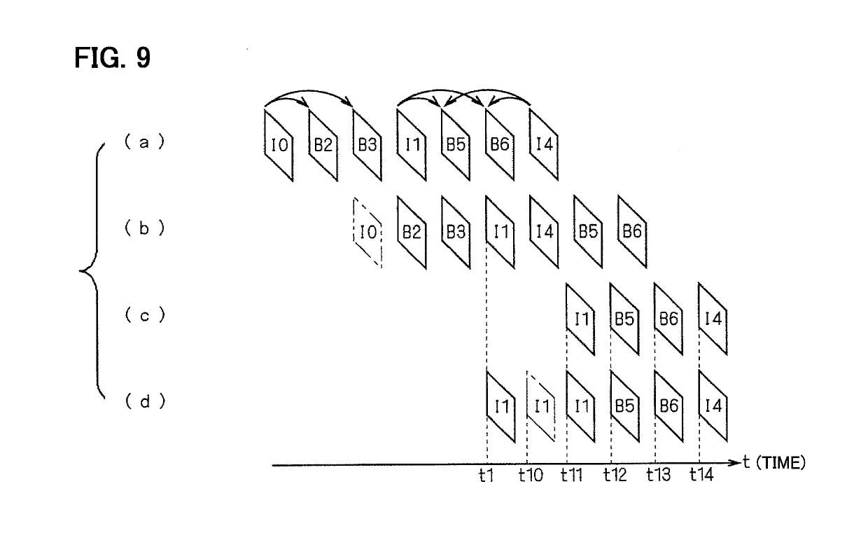

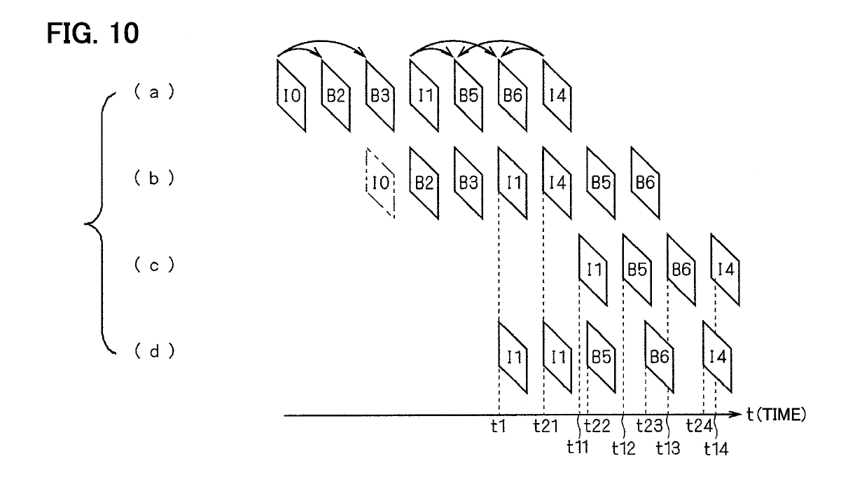

FIG. 9 schematically illustrates the frame display timing based on the operation of the display timing generation unit 17 in this embodiment. Like FIG. 4, FIG. 9 also shows the order of frames in the original picture and the order of frames in the transmitted and received stream. FIG. 9 shows the frame display timing in the conventional art as a ‘normal display’ and the frame display timing in this embodiment as a ‘high-speed channel selection display’. In FIG. 9, the frames of the original picture are shown at (a), the frames in the transmitted and received stream are shown at (b), the frames of the normal display are shown at (c), and the frames of the high-speed channel selection display are shown at (d). For ease of understanding, delays such as encoding delays, transmission delays, and decoding delays are expressed as zero in FIG. 9. It is also assumed that the delays and processing times do not fluctuate.

If frame I0 is missing, as indicated by phantom lines in the same way as shown in FIG. 4, and the transmitted stream was received starting from B2, the first decodable and displayable frame following the start of stream reception is I1. The decode timing of the first decodable frame I0 and the display timing of the displayable frame I0 are also time t1 in this embodiment.

In this embodiment, following the first decode and display timings, there is a wait until the times specified by the input video data for the next decode and display timings. More specifically, the decodable timing of the second decodable frame I4 is not the time t2 when it becomes decodable as shown in FIG. 4, but the decode time indicated by the DTS of the decodable frame I1 as shown at (d) in FIG. 9, and the displayable timing is the presentation time t14 indicated by the PTS.

The decodable timing of the third decodable frame B5 becomes the decode time t12 indicated by the DTS, and on the assumption of zero delays, the displayable timing also becomes the presentation time t12 indicated by the PTS. In this embodiment, after the first displayable frame I0 is displayed at time t1, the display in a unit of the GOP starting from frame I0 begins at the presentation time t11 indicated by the PTS of the first displayable frame I0.

In the first embodiment shown in FIG. 4, the display of in a unit of the GOP starting from frame I0 begins at time t2, between the time t1 when the first displayable frame T0 is displayed and the presentation time t1a indicated by the PTS of the first displayable frame I0. In the third embodiment, however, the GOP display starts not at time t10, between the time t1 when the first displayable frame I0 is displayed and the presentation time t11 indicated by the PTS of the first displayable frame I0, but at the presentation time t11 indicated by the PTS.

By waiting from the first decode and display timings until the time specified by the input video data for the next decode and display timings, in displaying the next frame it is possible to display the frame at the time specified by the input video data. Since the display timings of the second and subsequent frames are the presentation times tp specified by the input video data, the frames can be displayed at the same intervals as the frame intervals of the original picture.

Therefore, the time from when the input video stream starts or changes until the first video picture is displayed can be reduced, as in the first and second embodiments, and the second and subsequent frames can be displayed at the times specified by the input video data, at the same intervals as the frame intervals of the original picture, just by changing the decode and display timings of the second frame. Moreover, after an elapse of time, the decode time and display time can also be adjusted to the times intended by the broadcasting station or other transmitting party.

### Fourth Embodiment

The fourth embodiment uses correction methods differing from those used in the second and third embodiments. Except for the timing generation correction methods, the video display device in the fourth embodiment is identical to the video display devices in the second and third embodiments.

The timing generation correction process in this embodiment will be described. The process up to the generation of the first decode timing and display timing is the same as in the second embodiment. The corrected decode time tdα obtained by correcting the DTS's for the decode timings of the second and subsequent decodable frames is calculated as given by the equation (5) below.

tdα=td−(td0−tc0)×γ(0≦γ≦1) (5)

Here, (td0−tc0) indicates the difference between the decode time td0 indicated by the DTS in the first decodable frame and the time tc0 of the actual decode timing time, and γ represents a decode time correction coefficient. In this embodiment, the decode time correction coefficient γ shown in equation (5) is reduced over time from 1 to 0. This brings the decode timing closer to the time specified by the input video data, or the decode time td indicated by the DTS, as time passes.

The corrected presentation time tpα obtained by correcting the PTS's for the display timings of the second and subsequent displayable frames is calculated as given by the equation (6) below.

tpα=tp−(tp0−tq0)×η(0≦η≦1) (6)

Here, (tp0−tq0) expresses the difference between the presentation time tp0 indicated by the PTS of the first decodable frame and the time tq0 of the actually generated display timing, and represents a presentation time correction coefficient. In this embodiment, the presentation time correction coefficient η included in equation (6) is reduced over time from 1 to 0. This brings the display timing closer to the time specified by the input video data, namely the presentation time tp indicated by the PTS, as time passes.

FIG. 10 schematically illustrates the frame display timing based on the operation of the display timing generation unit 17 in this embodiment. Like FIG. 4, FIG. 10 also shows the order of frames in the original picture and the order of frames in the transmitted and received stream.

FIG. 10 shows the frame display timing in the conventional art as a ‘normal display’ and the frame display timing in this embodiment as a ‘high-speed channel selection display’. In FIG. 10, the frames of the original picture are shown at (a), the frames in the transmitted and received stream are shown at (b), the frames of the normal display are shown at (c), and the frames of the high-speed channel selection display are shown at (d). For ease of understanding, delays such as encoding delays, transmission delays, and decoding delays are expressed as zero in FIG. 10. It is also assumed that the delays and processing times do not fluctuate.

If frame I0 is missing, as indicated by phantom lines in the same way as shown in FIG. 4, and the transmitted stream was received starting from B2, the first decodable and displayable frame following the start of stream reception is I1. The decode timing of the first decodable frame I0 and the display timing of the displayable frame I0 are also time t1 in this embodiment.

The second and subsequent decode and display timings are corrected in stages toward the proper decode and display times in this embodiment. For example, as shown at (d) in FIG. 10, the decodable timing of the second decodable frame 14 is not the time t21 when it becomes decodable but a corrected decode time tdα obtained by a correction based on equation (5), and the displayable timing is time t24, which is a corrected presentation time tpα obtained by a correction based on equation (6).

The decodable timing of the third decodable frame B5 is time t22, which is a corrected decode time tdα obtained by a correction based on equation (5); on the assumption of zero delays, the displayable timing is also time t22, which is a corrected presentation time obtained by a correction based on equation (6). In this embodiment, after the first displayable frame I0 is displayed at time t1, the display in a unit of the GOP starting from frame I0 begins at a corrected presentation time t21 obtained by a correction based on the presentation time t1 indicated by the PTS of the first displayable frame I0.

Since the decode time correction coefficient γ shown in equation (5) and the presentation time correction coefficient η shown in equation (6) are reduced over time from 1 to 0 as described above, the frame display intervals increase gradually. For example, the intervals between times t21 and t22, times t22 and t23, and times t23 and t24 increase gradually in that order, as shown at (d) in FIG. 10.

By correcting the second and subsequent decode and display timings in stages toward the proper decode and display times, the time from when the input video stream starts or changes until the first video picture is displayed can be reduced as in the first to third embodiments, and after an elapse of time, the video picture can be displayed at the proper display times.

In this embodiment, the second and subsequent decode and display timings are corrected in stages toward the proper decode and display times, so an orderly and natural picture can be displayed even during the period from when the first video picture is displayed until the video pictures are displayed at the proper times.

### Fifth Embodiment

Next a video display device in a fifth embodiment of the invention will be described. Except for the decode timing generation process, the video display device in this embodiment is identical to the video display devices in the first to fourth embodiments, so the differing parts will be described and descriptions of the common parts will be omitted.

In the first to fourth embodiments, when there is a change in the video data input to the input terminal 10, the decode timing generation unit 14 generates a decode timing signal at the time of acquisition of the first entire decodable frame after the change. In the fifth embodiment, when there is a change in the video data input to the input terminal 10, the decode timing generation unit 14 generates a decode timing signal at a time of acquisition of part of the first decodable frame after the change; this time is earlier than the time of acquisition of the entire decodable frame.

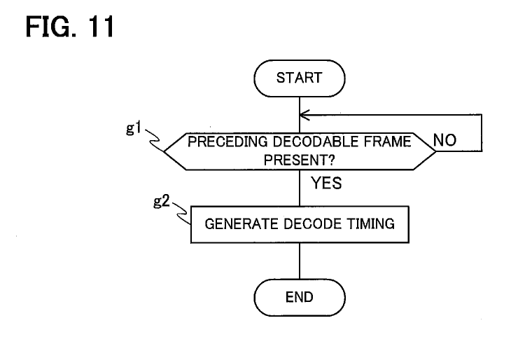

FIG. 11 is a flowchart illustrating a processing procedure in the decode timing generation unit 14 pertaining to the decode timing generation process in this embodiment. Like the flowchart shown in FIG. 2, the flowchart shown in FIG. 11 contemplates application of the video display device in this embodiment to a television receiver; when input of video data to the stream interface 11 starts immediately after the television receiver is turned on, or when the type, status, etc. of the input stream to the stream interface 11 changes owing to a broadcast channel selection operation by the user etc., this process starts with a transition to step g1.

In step g1, the decode timing generation unit 14 decides, on the basis of information included in the PES packets furnished from the PES processing unit 12, whether an on-the-fly decodable frame is present. Specifically, the decode timing generation unit 14 decides that an on-the-fly decodable frame is present in step g1 when it decides that a decodable frame is present and that part of the decodable frame, more precisely, a preset amount of video data pertaining to the decodable frame, has been accumulated in the decode buffer 13. When it is decided that a decodable frame is not present or that a decodable frame is present but the set amount of data has not been accumulated in the decode buffer 13, the decode timing generation unit 14 decides that an on-the-fly decodable frame is not present.

In this embodiment, an amount of data sufficient for the decoder 15 to start decoding the decodable frame, more precisely the minimum amount of data required for the start of decoding of the decodable frame by the decoder 15, is selected as the set amount of data. If it decided in step g1 that an on-the-fly decodable frame is present, the process proceeds to step g2; if it is decided that an on-the-fly decodable frame is not present, the process waits until an on-the-fly decodable frame is decided to be present.

In step g2, the decode timing generation unit 14 generates a decode timing signal and furnishes it to the decode buffer 13. After the processing in step g2 ends, the entire processing procedure ends.

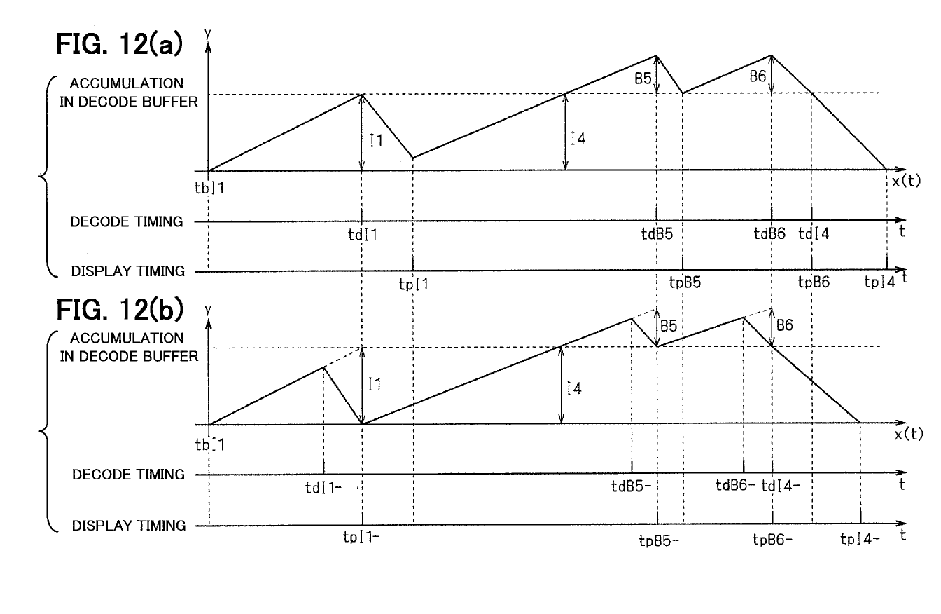

Next the on-the-fly-decodable-frame-present timing will be described. FIGS. 12(a) and 12(b) schematically illustrate the relation between accumulation in the decode buffer 13 and the decode timing and display timing. FIG. 12(a) illustrates the relation between accumulation in the decode buffer 13 and the decode timing and display timing in the first embodiment; FIG. 12(b) illustrates the relation between accumulation in the decode buffer 13 and the decode timing and display timing in the fifth embodiment. In FIGS. 12(a) and 12(b), the horizontal axis pertaining to accumulation in the decode buffer denotes the x-axis, and the vertical axis denotes the y-axis. The x-axis and the horizontal axes pertaining to decode timing and display timing represent time t. FIGS. 12(a) and 12(b) illustrate the transmission and reception of a transmitted and received stream identical to the transmitted and received stream shown at (b) in FIG. 4.

First the decodable-frame-present timing in the first embodiment will be described. As shown in FIG. 12(a), the decode buffer 13 successively accumulates data. Based on information included in the PES packets furnished from the PES processing unit 12, the decode timing generation unit 14 can obtain information concerning the picture type of each frame, such as whether the frame is an I frame or a B frame, at the beginning of the picture data pertaining to the frame. Therefore, on the basis of the information included in the PES packets furnished from the PES processing unit 12, the decode timing generation unit 14 can decide that the decode buffer 13 has started accumulating the data of frame I1, which is the first decodable frame, at time tbI1, so that the data accumulation starting time is time tbI1.

Data accumulation in the decode buffer 13 starts from time tbI1 and continues until time tdI1, which is the timing at which the whole of frame I1 becomes decodable, or the timing when the accumulation of all data pertaining to frame I1 is completed. When the accumulation of all data of frame I1 in the decode buffer 13 is completed at time tdI1, the decode timing generation unit 14 decides that this is the timing at which to decode frame I1 and generates a decode timing signal. This starts the output of data from the decode buffer 13 to the decoder 15 and the decoding of the data by the decoder 15. Time tdI1 is thus the timing at which a decodable frame is decided to be present, or the decodable-frame-present timing. The decode buffer 13 continues to accumulate data during the period from the decoding start time tdI1 to the time tpI1 of the end of the decoding of frame I1; during this period, data are both accumulated and output to the decoder 15.

Next, the decode buffer 13 continues accumulating data and accumulates data of the next input frame I4. The decode buffer 13 keeps on accumulating data. Waiting until all data of the frame B5 to be output at the next timing have been accumulated in the decode buffer 13, the decode timing generation unit 14 decides that this time tdB5 is the timing at which to decode frame B5. When accumulation of all data of frame B5 in the decode buffer 13 is completed at time tdB5, that is, the decode timing generation unit 14 decides that this is the timing at which to decode frame B5 and generates a decode timing signal, which starts the output of data from the decode buffer 13 to the decoder 15 and the decoding of the data by the decoder 15. The decode buffer 13 continues to accumulate data during the period from time tdB5 to the time tpB5 of the end of the decoding of frame B5; during this period, data are both accumulated and output to the decoder 15.

The decode buffer 13 continues to accumulate data. After waiting until all data of the frame B6 to be output at the next timing have been accumulated in the decode buffer 13, the decode timing generation unit 14 decides that this time tdB6 is the timing at which to decode frame B6. The decode buffer 13 continues to accumulate data during the period from time tdB6 to the time tpB6 when the decoding of frame B6 ends; during this period, data are both accumulated and output to the decoder 15.

After the time tpB6 at which the decoding of frame B6 ends, the decoder 15 can start the next decoding operation, so at time tpI4, which is identical to the time tpB6 at which the decoding of frame B6 ends, the decode timing generation unit 14 generates a decode timing signal for the frame I4 to be output at the next timing. The decode buffer 13 continues to accumulate data during the period from this time tdI4 to the time tpI4 at which the decoding of frame I4 ends; during this period, data are both accumulated and output to the decoder 15.

Next the on-the-fly-decodable-frame-present timing in this embodiment, shown in FIG. 12(b), will be described. The decision that data accumulation has started at time tbI1 is made as described above. Starting from time tbI1, data accumulate in the decode buffer 13, but in this embodiment, the decode timing generation unit 14 generates a decode timing signal at time tdI1− before the accumulation of all data of the frame I1 to be decoded is completed at time tdI1. Time tdI1− is a time that guarantees that if decoding starts at time tdI1− and is assumed to end at a time tpI1−, sufficient data to decode frame I1 will have been accumulated in the decode buffer 13 by time tpI1−. More specifically, the time at which an amount of data sufficient for the decoder 15 to start decoding the decodable frame, in this embodiment the minimum amount of data required by the decoder 15 to start decoding the decodable frame, is accumulated in the decode buffer 13 is selected as time tdI1−.

If the decode time is 0, the time tpI1− is ideally the time at which the accumulation of all data of frame I1 in the decode buffer 13 has been completed and is calculated as described below. First, the rate of data accumulation in the decode buffer 13 is linearly approximated as shown in the equation (7) below.

y=ax (a>0) (7)

The rate of data output from the decode buffer 13 to the decoder 15 is linearly approximated as shown by the equation (8) below.

y=b(x−tdI1) (b<0) (8)

When the data accumulation rate in the decode buffer 13 and the rate of data output from the decode buffer 13 to the decoder 15 are linearly approximated by equations (7) and (8), respectively, the x coordinate of the intersection of the line representing equation (7) and the line representing equation (8) becomes time tdI1−. Similarly, the decode timing generation unit 14 generates decode timing signals to have the decoder 15 start decoding frames B5, B6, I4 at times tdB5−, tdB6−, tdI4−, preceding the times tdB5−, tdB6−, tdI4− at which all data of these frames are accumulated.

Therefore, in comparison with the first embodiment, the decode start timings of decodable frames can be advanced in this embodiment. The decode end timings of the decoder 15 can thereby be advanced and the frames can be displayed at times tpB5−, tpB6−, tpI4− earlier than the corresponding frame display times tpI1, tpB5, tpB6, tpI4 in the first embodiment.

According to this embodiment as described above, when there is a change in the video data input to the input terminal 10, a decode timing signal is generated at a time when part of the first decodable frame after the change has been obtained, before the time at which the entire decodable frame as been obtained. Therefore, frames can be displayed at earlier timings than in the first to fourth embodiments.

In this embodiment, the decode timing generation unit 14 generates decode timing signals for the second and subsequent frames when an on-the-fly decodable frame is decided to be present, and the display timing generation unit 17 generates display timing signals when decoding of the corresponding frames is completed. The decode timing signals for the second and subsequent frames may also be generated when the reference time ts indicated by the STC agrees with the corrected decode time tdα, and the display timing signals may be generated when the reference time ts indicated by the STC agrees with the corrected presentation time tpα, as in the second to fourth embodiments.

### Sixth Embodiment

The sixth embodiment of the present invention uses a timing generation method differing from that used in the first embodiment. Except for the decode timing generation method and display timing generation method, the video display device in this embodiment is identical to the video display device in the first embodiment.

In the first embodiment, when there is a change in the video data input to the input terminal 10, the decode timing generation unit 14 generates a decode timing signal at the time when part or all of the first decodable frame is acquired after the change. In the sixth embodiment, a contrasting method of obtaining the time when part or all of the decodable frame is acquired will be described.

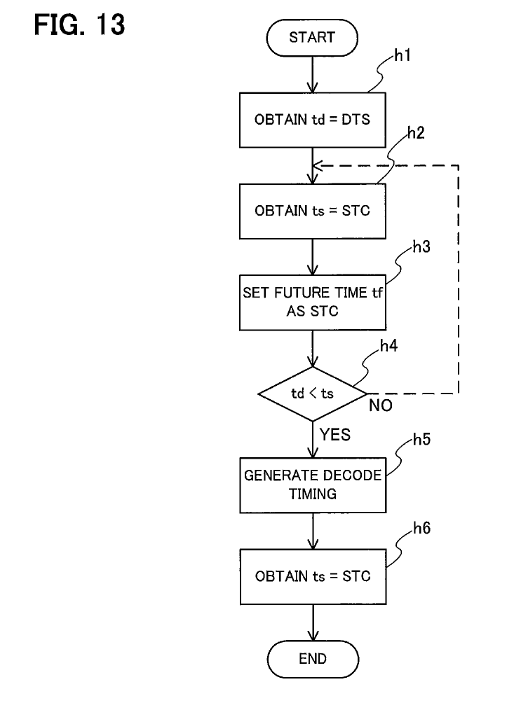

FIG. 13 is a flowchart illustrating a processing procedure in the decode timing generation unit pertaining to the decode timing generation process in this embodiment.

In step h1, the decode timing generation unit obtains a decode time td from the DTS. When a decode time td has been obtained by the decode timing generation unit in step h1, the process proceeds to step h2.

In step h2, the decode timing generation unit obtains an STC reference time ts. When an STC reference time ts has been obtained by the decode timing generation unit in step h2, the process proceeds to step h3.

In step h3, the decode timing generation unit sets a future time tf, sufficiently far ahead of the decode time td, as the STC reference time ts (ts=tf=ts+β, β>0). When ts has been set to a future time in step h3, the process proceeds to step h4.

In step h4, the decode timing generation unit compares the reference time ts with the decode time td. If the reference time ts is decided to follow the decode time td (td<ts), the process proceeds to step h5; if the reference time ts is decided to precede the decode time td, the process returns to step h2, and the processing described above is performed. When the reference time ts is a future time tf following time td, the process proceeds to step h5.

In step h5, the decode timing generation unit generates a decode timing signal and furnishes it to the decode buffer. When a decode timing has been generated and furnished to the decode buffer in step h5, the process proceeds to step h6.

In step h6, the STC time is obtained as the reference time. After the processing in step h6 ends, the entire processing procedure ends. In this embodiment, a decode timing signal is thus generated immediately after decoding starts.

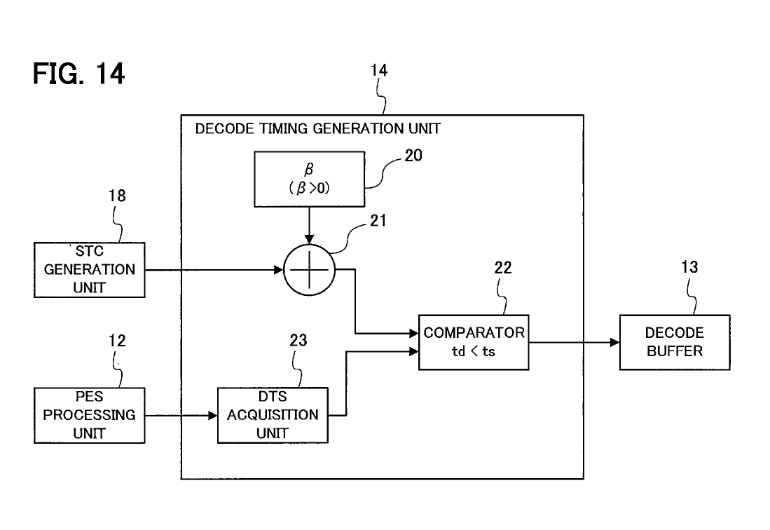

FIG. 14 is a block diagram illustrating the structure of a decode timing generation unit 14 pertaining to the decode timing generation process in this embodiment.

A DTS acquisition unit 23 obtains a DTS from the data included in the PES header furnished from the decode timing generation unit 14 and outputs it to a comparator 22. An adder 21 adds the STC data input from the STC generation unit 18 and a positive value β 24 and outputs the result to a comparator 21. The comparator 21 compares the data input from the adder 21 and the DTS acquisition unit 23 and outputs the result as a decode timing to the decode buffer 13.

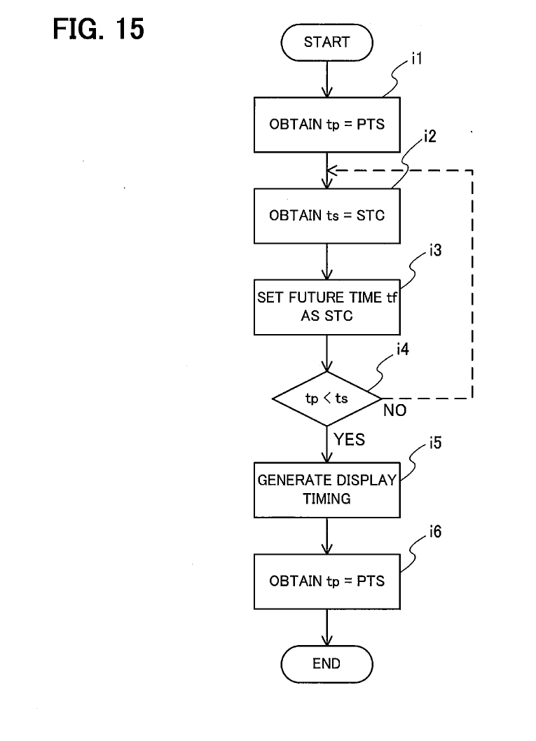

FIG. 15 is a flowchart illustrating a processing procedure in the display timing generation unit pertaining to the display timing generation process in this embodiment.

In step i1, the display timing generation unit obtains a presentation time tp from the PTS. When a presentation time tp has been obtained by the display timing generation unit in step i1, the process proceeds to step i2.

In step i2, the display timing generation unit obtains an STC reference time ts. When an STC reference time ts has been obtained by the display timing generation unit in step i2, the process proceeds to step i3.

In step i3, the display timing generation unit sets a future time tf, sufficiently far ahead of the presentation time tp, as the STC reference time ts (ts=tf=ts+β, β>0). When ts has been set to a future time in step i3, the process proceeds to step i4.

In step i4, the decode timing generation unit compares the reference time ts and the presentation time tp. If the reference time ts is decided to follow the presentation time tp (tp<ts), the process proceeds to step i5; if the reference time ts is decided to precede the presentation time tp, the process returns to step i2 and the processing described above is performed. When the reference time ts is a future time tf following time tp, the process proceeds to step i5.

In step i5, the display timing generation unit generates a display timing signal and furnishes it to the frame buffer. When a display timing has been generated and furnished to the frame buffer in step i5, the process proceeds to step i6.

In step i6, the STC time ts is obtained as the reference time. After the processing in step i6 ends, the entire processing procedure ends. In this embodiment, the display timing signal is generated immediately after the presentation process starts.

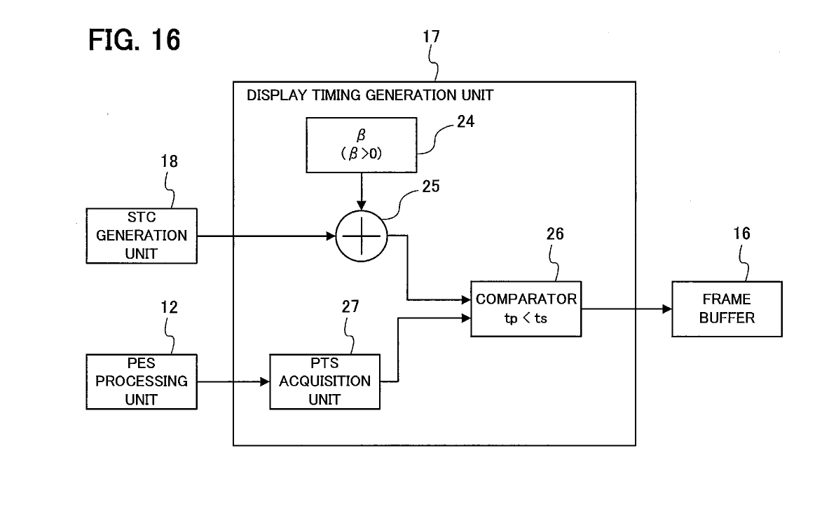

FIG. 16 is a block diagram illustrating the structure of the display timing generation unit 17 pertaining to the display timing generation process in this embodiment.

A PTS acquisition unit 27 obtains a PTS from the data included in the PES header furnished from the display timing generation unit 17 and outputs it to a comparator 26. An adder 25 adds a positive value β 24 to the STC data input from the STC generation unit 18 and outputs the result to the comparator 26. The comparator 26 compares the data input from the adder 25 and the PTS acquisition unit 27 and outputs the result as a decode timing to the frame buffer 16.

Although the timing generation time is advanced by specifying a reference time in the future in this embodiment, the same effect can be produced by delaying the decode time DTS and presentation time. It will be appreciated that other methods that advance the timing generation time may also be employed.

In this embodiment, when there is a change in the video data input to the input terminal 10, a decode timing signal is generated at a time immediately after the acquisition of the DTS of the first decodable frame after the change, and in the display timing generation process, a display timing is generated at a time immediately after the PTS is obtained. When the received stream is decided to include a decodable frame, in this embodiment a decode timing signal is generated immediately, regardless of the DTS, and the decodable frame is decoded. When a displayable frame is decided to be present, a display timing signal is generated immediately, regardless of the PTS, and the displayable frame is displayed. In this embodiment, the system time is changed by a simple correction formula, the decodable frame that arrives first in the received stream is decoded immediately, and the decoded data are displayed immediately.

This embodiment was described on the assumption that the video stream data do not fluctuate and that the time needed for processing in the video display device is zero, but the decode time may be corrected as described in the second to fifth embodiments.

### Seventh Embodiment

The seventh embodiment of the present invention uses a timing generation method differing from that used in the sixth embodiment. Except for the decode timing generation method and display timing generation method, the video display device in this embodiment is identical to the video display device in the sixth embodiment.

The description given above of the sixth embodiment dealt with cases in which the PCR (Program Clock Reference) does not change greatly in a discontinuous way from when the DTS is obtained until the decode timing is generated, and from when the PTS is obtained until the display timing is generated (the PCR changes mentioned below denote large discontinuous changes rather than normal increments). The description of the seventh embodiment will deal with an embodiment of a method of generating decode timings and display timings even when a PCR change causes the SCR to change (denoting, like the PCR change, a large discontinuous change rather than a normal increment).

The decode timing generation method will be described first.

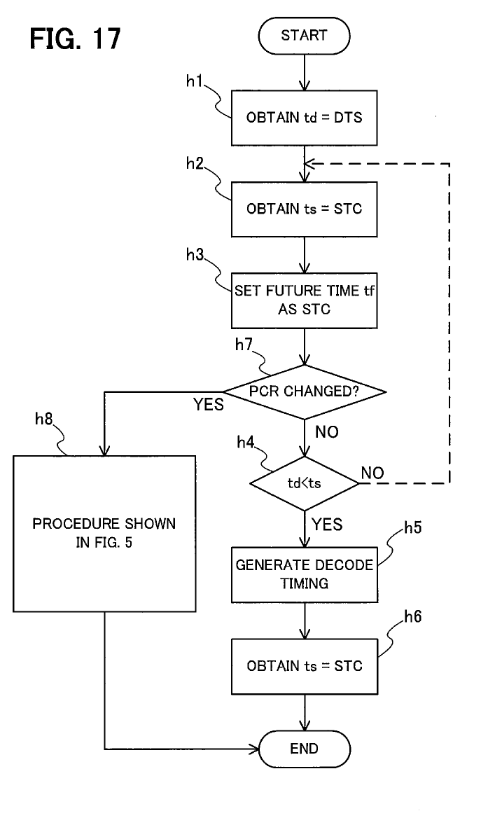

FIG. 17 is a flowchart illustrating a processing procedure in the decode timing generation unit pertaining to the decode timing generation process in this embodiment.

In step h1, the decode timing generation unit obtains a decode time td from the DTS. When a decode time td has been obtained by the decode timing generation unit in step h1, the process proceeds to step h2.

In step h2, the decode timing generation unit obtains an STC reference time ts. When an STC reference time ts has been obtained by the decode timing generation unit in step h2, the process proceeds to step h3.

In step h3, the decode timing generation unit sets a future time tf, sufficiently far ahead of the decode time td, as the STC reference time ts (ts=tf=ts+β, β>0). When ts has been set to the future time in step h3, the process proceeds to step h7.

In step h7, whether the PCR has changed after the DTS was obtained in step h1 is detected. If a PCR change is detected, the process proceeds to step h8; if a PCR change is not detected, the process proceeds to step h4.

In step h8, processing steps are carried out in conformance with the processing procedure (FIG. 5) in the decode timing generation unit pertaining to the decode timing generation process in the conventional art. After the processing in step h8 ends, the entire processing procedure ends.

In step h4, the decode timing generation unit compares the reference time ts and the decode time td. If the reference time ts is decided to follow the decode time td (td<ts), the process proceeds to step h5; if the reference time ts is decided to precede the decode time td, the process returns to step h2, and the processing described above is performed. When the reference time ts is a future time tf following time td, the process proceeds to step h5.

If, despite the setting of a future time by adding β to the reference time in step h3, the STC has changed by more than the value of β in the past, the process returns to h2 and cannot proceed to step h5.

In step h5, the decode timing generation unit generates a decode timing signal and passes it to the decode buffer. When a decode timing has been generated and furnished to the decode buffer in step h5, the process proceeds to step h6.

In step h6, the STC time ts is obtained as the reference time. After the processing in step h6 ends, the entire processing procedure ends. In this embodiment, a decode timing signal is generated even when there is a PCR change and the STC is altered into the past before the change.

Next the display timing generation method will be described.

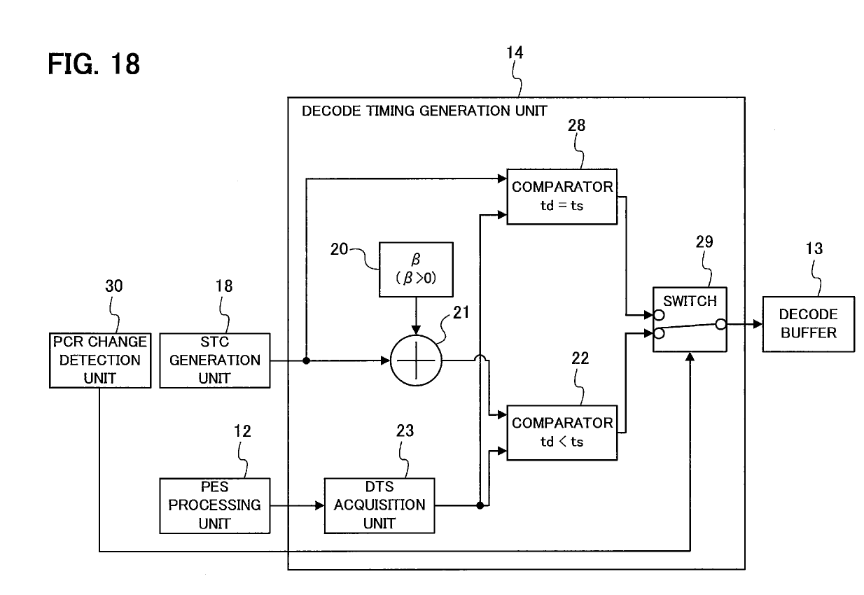

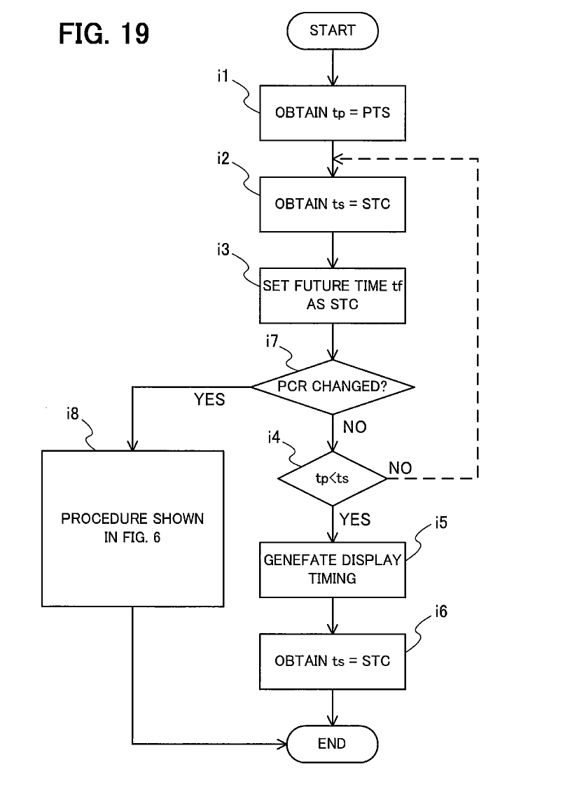

FIG. 18 is a block diagram illustrating the structure of the decode timing generation unit pertaining to the decode timing generation process in this embodiment.

A DTS acquisition unit 23 obtains the DTS from data included in the PES headers furnished from the decode timing generation unit 14 and outputs it to a comparator 22. An adder 21 adds a positive value β 20 to the STC data input from the STC generation unit 18 and outputs the result to a comparator 21. The comparator 21 compares data input from the adder 21 and the DTS acquisition unit 23 and outputs the result to a switch 29. A comparator 28 compares data input from the STC generation unit 18 and the DTS acquisition unit 23 and outputs the result to the switch 29. The switch 29 receives data from the comparator 22 and comparator 28, receives data from the result of a detection made by a PCR change detection unit 30 as a switching signal, and outputs decode timings to the decode buffer 13.

FIG. 19 is a flowchart illustrating a processing procedure in the display timing generation unit pertaining to the display timing generation process in this embodiment.

In step i1, the display timing generation unit obtains a presentation time tp from the PTS. When the presentation time tp has been obtained by the display timing generation unit in step i1, the process proceeds to step i2.

In step i2, the display timing generation unit obtains an STC reference time ts. When the STC reference time ts has been obtained by the display timing generation unit in step i2, the process proceeds to step i3.

In step i3, the display timing generation unit sets a future time tf, sufficiently far ahead of the presentation time tp, as the STC reference time ts (ts=tf=ts+β, β>0). When ts has been set to a future time in step i3, the process proceeds to step i7.

In step i7, whether the PCR has changed after the DTS was obtained in step i1 is detected. If a PCR change is detected, the process proceeds to step i8; if a PCR change is not detected, the process proceeds to step i4.

In step i8, processing steps are carried out in conformance with the processing procedure (FIG. 6) in the display timing generation unit pertaining to the display timing generation process in the conventional art. After the processing in step i8 ends, the entire processing procedure ends.

In step i4, the decode timing generation unit compares the reference time ts and the presentation time tp. If the reference time ts is decided to follow the presentation time tp (tp<ts), the process proceeds to step i5; if the reference time ts is decided to precede the presentation time tp, the process returns to step i2, and the processing described above is performed. When the reference time ts is a future time tf following time tp, the process proceeds to step i5.

If, despite the setting of a future time by adding β to the reference time in step i3, the STC has changed by more than the value of β in the past, the process returns to step i2 and cannot proceed to step i5.

In step i5, the display timing generation unit generates a display timing signal and passes it to the frame buffer. When the display timing has been generated and passed to the frame buffer in step i5, the process proceeds to step i6.

In step i6, the STC time ts is obtained as the reference time. After the processing in step i6 ends, the entire processing procedure ends. In this embodiment, a display timing signal is generated even when there is a PCR change and the STC is altered into the past before the change.

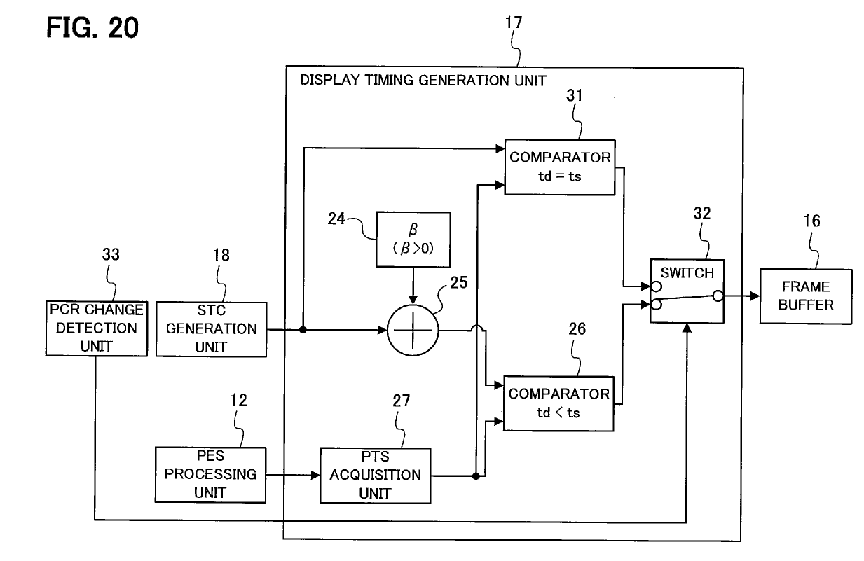

FIG. 20 is a block diagram illustrating the structure of the display timing generation unit 17 pertaining to the display timing generation process in this embodiment.

A PTS acquisition unit 27 obtains a PTS from the data included in the PES header furnished from the display timing generation unit 17 and outputs it to a comparator 26. An adder 25 adds the STC data input from the STC generation unit 18 and a positive value β 24 and outputs the result to a comparator 26. The comparator 26 compares data input from the adder 25 and the PTS acquisition unit 27 and outputs the result to a switch 32. The switch 32 receives data input from the comparator 26 and a comparator 31, receives data from the result of a detection made by a PCR change detection unit 33 as a switching signal, and outputs decode timings to the frame buffer 16.

Although the decode and display timings are returned to the conventional timings when a PCR change occurs in this embodiment, the same effect can be produced by delaying the timing of the STC change following the PCR change until the decode and delay timings have been generated. Alternatively, the DTS and PTS values may be adjusted in accordance with the change in the STC so that timings are generated. It will be appreciated that other methods may also be used, provided they produce timing generation.

In this embodiment, decode and display timings are generated even if a channel selection operation starts just before the timing at which the PCR is changed by the broadcasting station or other transmitting party and the PCR change occurs during the period from DTS acquisition to decode timing generation or from PTS acquisition to display timing generation. Thus in this embodiment, a stable picture is displayed even when the transmitted signal changes.

### REFERENCE CHARACTERS

1 video display device, 11 stream interface, 12 PES processing unit, 13 decode buffer, 14 decode timing generation unit, 15 decoder, 16 frame buffer, 17 display timing generation unit, 18 STC generation unit, 20 constant β, 21 adder, 22 comparator, 23 DTC acquisition unit, 24 constant β, 25 adder, 26 comparator, 27 PTS acquisition unit, 28 comparator, 29 switch, 30 PCR change detection unit, 31 comparator, 32 switch, 33 PCR change detection unit.

1. A video display device for decoding and displaying video data including a plurality of coded frames, comprising:
input means for input of the video data;
decode timing generation means for generating decode timing signals indicating decode timings of the coded frames of the video data input to the input means;
decoding means for decoding the coded frames of video data input to the input means in accordance with the decode timing signals;
display timing generation means for generating display timing signals indicating display timings at which to output the frames decoded by the decoding means; and
output means for output of the decoded frames in accordance with the display timing signals; wherein
when the video data input to the input means change, the display timing generation means sets a reference time in the future and, at a time immediately following acquisition of a PTS of a first decodable frame thereafter, generates a display timing of the decodable frame.

2. A video display device for decoding and displaying video data including a plurality of coded frames, comprising:
input means for input of the video data;
decode timing generation means for generating decode timing signals indicating decode timings of the coded frames of the video data input to the input means;
decoding means for decoding the coded frames of video data input to the input means in accordance with the decode timing signals;
display timing generation means for generating display timing signals indicating display timings at which to output the frames decoded by the decoding means; and
output means for output of the decoded frames in accordance with the display timing signals; wherein
when there is a change in the video data input to the input means, the decode timing generation means sets a reference time in the future and, at a time immediately following acquisition of a DTS of a first decodable frame thereafter, generates a decode timing signal of the decodable frame; and
when there is a change in the video data input to the input means, the display timing generation means sets a reference time in the future and, at a time immediately following acquisition of a PTS of a first displayable frame thereafter, generates a display timing of the displayable frame.

3. The display device of claim 2, wherein the time at which the DTS of the first decodable frame is acquired is the time at which all data of the decodable frame have been acquired.

4. The display device of claim 2, wherein the time at which the DTS of the first decodable frame is acquired is a time at which part of the data of the decodable frame has been acquired, preceding the time at which all data of the decodable frame have been acquired.

5. The display device of claim 2, wherein after a time when the first decodable frame is acquired, when a subsequent decodable frame is acquired, the decode timing signal of the subsequent decodable frame is generated at a corrected decode time obtained by correcting a decode time defined for the subsequently decodable frame.

6. The display device of claim 1, wherein when a subsequently displayable frame is acquired after the time at which the first displayable frame is acquired, the display timing generation means generates the display timing signal of the subsequently displayable frame at a corrected presentation time obtained by correcting the presentation time defined for the subsequently displayable frame by use of a difference.

7. The display device of claim 6, wherein the difference is a fixed value.

8. The display device of claim 6, wherein the difference is zero.

9. The display device of claim 6, wherein the difference is a stepped value that sequentially approaches zero over a plurality of subsequently displayable frames.

10. The display device of claim 1, further comprising a PCR change detection unit for detecting a change in a PCR included in the video data, wherein:
when the video data input to the input means change, after the decode timing generation means sets a reference time in the future, if the PCR change detection unit does not detect a change in the PCR, the decodable frame is decoded immediately; and
the display timing generation means displays the displayable frame immediately.
